(19) United States
(12) Patent Application Publication
(10) Pub. No.: US 2022/0212280 A1
(43) Pub. Date: Jul. 7, 2022

(54) WELDING-ROLLING INTEGRATED COMPOSITE FORMING METHOD FOR METAL MATERIAL, AND DEVICE THEREOF

(71) Applicant: DALIAN UNIVERSITY OF TECHNOLOGY, Dalian, Liaoning (CN)

(72) Inventors: Gang SONG, (US); Liming LIU, (US); Zhaodong ZHANG, (US); Hongyang WANG, (US); Daxin REN, (US)

(21) Appl. No.: 17/594,743

(22) PCT Filed: Mar. 10, 2020
(86) PCT No.: PCT/CN2020/078500

§ 371 Date: Oct. 28, 2021

(30) Foreign Application Priority Data
Mar. 3, 2020 (CN) 202010139266.X
Mar. 3, 2020 (CN) 202010139286.7

(51) Int. Cl. B23K 11/06

(52) U.S. Cl. CPC B23K 11/061

(57) ABSTRACT

A welding-rolling integrated composite forming method uses the low heat input wire filling welding method to cooperate with the optimization of the welding process, and at the same time the rolling device is used to roll the weld reinforcement area of the welded joint, realizing the precise control of the structure and properties of each area of the welded joint by using the plastic flow and deformation strengthening effect of the weld reinforcement of the welded joint during rolling process. The integrated composite forming device adjusts the distances between the welding mechanism, the rolling mechanism and the metal sheet to-be-welded and rolled by the coordination of each mechanism, and carries out synchronous rolling on the weld reinforcement of the welded joint.

### TECHNICAL FIELD

The present disclosure belongs to the technical field of material engineering, and relates to a metal material processing method and device, and more particularly, relates to a welding-rolling integrated composite forming method for metal material and a device thereof.

### BACKGROUND ART

As a common basic manufacturing technology, welding has been widely used in aviation, spaceflight, nuclear energy, ships and warships, automobiles and many other fields. However, it is well known that the mechanical properties of the welded joint, especially the dynamic load property such as fatigue load, are greatly reduced due to the welded joint inevitably has softening problem in welding heat affected zone and weld defects such as macro and micro pores and cracks. Therefore, welded joints are still weak parts of the key components. For example, for heat treatment strengthened metal materials, mainly including high strength aluminum alloy processed by solution and aging heat treatments, quenched and tempered high strength steel and ultra-high strength steel and other metal materials, are easily affected in the welding process by the welding thermal cycle, resulting in the softening problem of the welding heat affected zone. At present, the mechanical properties of the above-mentioned high strength aluminum alloy welded joints welded by traditional welding methods are only about 50% to 60% of the base metal. For another example, for the metals sensitive to hydrogen solubility with temperature changes, such as aluminum alloy, magnesium alloy, steel with high sulfur content and casting metal whose base metal itself contains shrinkage cavities and cracks, the welded joints of these metal materials are easily to produce weld defects such as pores and cracks, so that the mechanical properties of the welded joints, especially the dynamic load properties such as fatigue load, are only 20% to 50% of the base metal. In view of the above problems, in the actual production and application, the methods of optimizing welding process, increasing plate thickness and improving safety factor are mainly adopted to meet the requirements of parts design and service reliability, which is difficult to meet the development needs of high-end equipment manufacturing industry to save materials and reduce consumption, high service conditions and high service life.

In order to improve the mechanical properties of welded joints, scholars at home and abroad have carried out active and effective work on reducing welding heat input and adopting post-welding treatment. For example, for the heat treatment strengthened aluminum alloy, fusion welding methods such as laser welding with low heat input and cold metal transition (CMT) arc welding can make the tensile strength of the welded joint reach 65% to 75% of the base metal; using the solid phase welding methods represented by friction welding and friction stir welding, the tensile strength of the welded joint can reach 70% to 80% of the base metal by optimizing the technological parameters, and even some brands of high strength aluminum alloy can reach more than 90%; using post-welding treatment such as post-welding heat treatment, deep cryogenic treatment and shot peening, the microhardness, plasticity and microstructure uniformity of the welded joint can be improved in different degrees, of which shot peening can also reduce the welding residual stress and improve corrosion resistance of the welded joint, but the above post-processing means is usually complex and has slow process; and the post-welding heat treatment can affect the performance of the original base metal, which is difficult to solve the problems of welding pores and cracks at the same time; and also the above methods are restricted by the shape and structure of the parts, and the application scope is limited to some extent.

Plastic processing is an effective way to improve the properties of metal materials. The irreversible plastic deformation is applied on the metal materials by external force, which can significantly improve the consistency of metal materials, improve the casting defects such as pores, cracks and shrinkage porosity, and also cause grain deformation and distortion inside metal materials, increase dislocation density, induce fine grain strengthening and precipitation strengthening of the second phase particles, and improve the comprehensive mechanical properties of metal materials such as strength or hardness.

Therefore, if the welding method can be combined with the plastic processing method, it will be an effective way to improve the properties of welded joints. At present, the literatures related to welding and plastic deformation composite processing mainly focus on the preparation of composite plates. For example, in “High Frequency Welding-rolling Multilayer Composite Plate Production Device and Method (CN 201310403515.1)”, the purpose of the high frequency welding process is to realize the full-lap connection of multilayer metal plates; but rolling, as a typical plastic processing method, aims to improve the combining capacity between layers of multilayer composite plates, and at the same time achieve the preparation of multilayer metal composite plates with continuous length. However, there is a lack of research on welding-rolling method for strengthening the properties of welded joints.

Therefore, it is urgent to develop a welding-rolling composite forming method and a device which can enhance the overall mechanical properties of welded joints by strengthening the deformation of local areas of welded joints.

### SUMMARY OF THE INVENTION

According to the above mentioned problems such as softening, pores and crack defects in the existing welded joints, the present disclosure discloses a welding-rolling integrated composite forming method for metal material and a device thereof. The method of the present disclosure adopts rolling the weld reinforcement area of the welded joint simultaneously in the welding process. The present disclosure can solve the softening problem of the welded joint, and also can improve the weld defects such as pores and cracks, and has good technological adaptability and good production efficiency.

The technical solutions adopted by the present disclosure are as follows:

A welding-rolling integrated composite forming method for metal material, implementing the welding-rolling integrated composite forming on a sheet metal to be welded and rolled, wherein a welded joint with a certain weld reinforcement is obtained by using a low heat input wire filling welding method in the welding process, and the welding heat input is controlled to make a softened region with the weakest performance of the welded joint close to a welding seam; in the welding process, a weld reinforcement area of the welded joint is rolled by a rolling device simultaneously; and coordinated regulation of a rolling temperature and a rolling deformation is realized according to setting a distance D between a welding gun and a roller and a distance HR between the rollers or a distance H between the roller and the surface of the sheet metal to be welded and rolled. By using the plastic flow and deformation strengthening effect produced by the weld reinforcement of the welded joint during rolling process, realizing the accurate control of the structures and properties of each area of the welded joint, and improving the defects such as pores and cracks.

Further, the sheet metal to be welded and rolled includes a sheet metal whose welded joint is prone to generate heat affected zone softening or a sheet metal which is easy to produce welding pores and welding cracks.

Further, the sheet metal is selected from but not limited to high strength aluminum alloy after solid solution and aging heat treatment, high strength steel after quenching and tempering treatments, ultra-high strength steel, 2-series aluminum alloy, coated high strength steel plate and casting metal materials.

Further, the low heat input wire filling welding method refers to a welding with filler wire assisted by forced cooling, a cold metal transition metal inert gas arc welding (CMT), a high energy beam (laser, electron beam) welding with filler wire and a high energy beam (laser)-arc composite welding with filler wire and other welding methods with filler wire having the same low heat input characteristics.

Further, in the welding process, according to the material types and the plate thickness of the metal to optimize the welding process; mainly by optimizing a wire filling quantity of per unit welded joint length and welding heat input, the position of the softened region of the welding joint is associated with the weld reinforcement of the welded joint, namely through subsequent rolling deformation, i.e., synergistic plastic deformation can be achieved between the weld reinforcement and the softened region of the welded joint by subsequent rolling deformation, and the deformation and strengthening of the softened region can be realized.

Further, the rolling device is a double-roller device or a single-roller device, and a size of the roller is determined according to the material type, mechanical properties and rolling force of the welded sheet metal, and the size of the weld reinforcement of the welded joint.

Further, the distance D between the welding gun and the roller, a required cooling time S_{T} of the welded joint reaching a setting rolling temperature T, and a rolling speed V have a relation of D=S_{T}×V, wherein the rolling temperature T is determined according to a metal material plastic state diagram of the sheet metal to be welded and rolled and a deformation strengthening effect, and ST represents the cooling time from the peak temperature to the required rolling temperature in a welding thermal cycle curve at the rolling position.

Further, the distance H_{R} between the rollers or the distance H between the roller and the surface of the sheet metal to be welded and rolled is related to the metal material type of the sheet metal to be welded and rolled, a plate thickness H₁, a weld reinforcement H₂ of the welded joint and the required deformation strengthening effect, and H₁≤H_{R}<H₁+H₂ for the double-roller device and H<H₂ for the single-roller device.

The present disclosure also provides a welding-rolling integrated composite forming device for metal material, which mainly utilizes the mutual cooperation of an lifting mechanism, a spatial size adjusting mechanism, a welding mechanism and a rolling mechanism to realize the synchronization of the welding of metal material and the rolling of the weld reinforcement of the welded joint after welding, including:

a frame, which is an integral or a split-type frame body having a support structure, and is used for fixing a lifting mechanism and a spatial size adjusting mechanism;

a lifting mechanism, which is cooperated with a rolling mechanism to adjust the distance between the rolling mechanism and the sheet metal to be welded and rolled, wherein the sheet metal to be welded and rolled is clamped by a fixing mechanism fixed on the frame to limit its fluctuation in the vertical direction or its movement in all directions;

a spatial size adjusting mechanism, which is used to clamp a welding mechanism and adjust the positions of the welding mechanism and the sheet metal to be welded and rolled and a relative distance between the welding mechanism and the rolling mechanism;

a welding mechanism, which has a characteristic of low heat input wire filling welding, and is used to weld the sheet metal to be welded and rolled, to obtain a welded joint with a certain weld reinforcement after welding; and

a rolling mechanism, which is driven by a driving mechanism and used for synchronous rolling of the weld reinforcement of the welded joint.

Further, two groups of the lifting mechanism are arranged; the lifting mechanism is in a structural form of hydraulic push rod matching with lifting base and is driven by oil pump; a fixed end of the hydraulic push rod is fixed on the frame, and a moving end is fixed on the lifting seat; and the lifting base sliding fits in sliding chutes on side walls of the frame to realize up and down movement.

Further, the spatial size adjusting mechanism adopts a structural form of sliding blocks cooperated with a rotating distance adjusting device, the sliding blocks including up and down moving sliding block and horizontally and vertically moving sliding block; the up and down sliding block and the horizontally and vertically moving sliding block are combined by the rotating distance adjustment device and the welding gun is clamped by a clamping mechanism to adjust the welding position.

Further, the rotating distance adjusting device adopts a form of rotating shaft cooperating with moving end block and fixing end block that are respectively fixed on the corresponding moving sliding blocks to adjust the relative position between the moving sliding blocks.

Further, the welding mechanism includes a wire feeding device, a welding gun and a welding heat source; the characteristics of low heat input wire filling welding refers to but not limited to high energy beam wire filling welding, high energy beam-arc composite wire filling welding, cold metal transition metal inert gas arc welding, alternating current arc melt gas shielded welding and other methods with the same low heat input wire filling welding.

Further, the rolling mechanism adopts a structural form of double-roller or single-roller.

Further, when the rolling mechanism adopts the double-roller structure, a upper roller is rotationally connected to the two lifting bases of the lifting mechanism, and a lower roller is rotationally connected to the middle and lower part of the frame. Accordingly, the driving mechanism is drivingly connected to the upper and lower rollers by adopting an actuating motor cooperating with a reducer and a gear set.

Further, when the rolling mechanism adopts the single-roller structure, the frame adopt a split-type frame, at the upper part a walking mechanism having movement characteristics moves horizontally along a fixed frame base at the lower part through a sliding chute track. The lifting mechanism and the spatial size adjusting mechanism are both fixed on the walking mechanism, and the roller is rotationally connected to the two lifting bases in the lifting mechanism. Accordingly, the driving mechanism is drivingly connected to the walking mechanism and the frame base by adopting an actuating motor cooperating with a gear and a rack.

Further, the fixing mechanism is provided with a cooling device to shunt fusion welding heat source.

The present disclosure also discloses a welding-rolling method of the above welding-rolling integrated composite forming device for metal material, including the following steps:

S1. inserting the sheet metal to be welded and rolled into the fixing mechanism, according to the size of the sheet metal to be welded and rolled, adjusting and pressing it;

S2. according to a preset rolling reduction, controlling the rolling mechanism by the lifting mechanism to adjust the distance between the roller and the surface of the sheet metal to be welded and rolled, and to adjust the driving mechanism to drive normally;

S3. according to the position of the sheet metal to be welded and rolled, preset welding parameters and the preset distance between the welding gun and the roller, adjusting the spatial position of the welding mechanism by the spatial size adjusting mechanism, to make its spatial position fixed; and

S4. according to the welding speed and the rolling speed, adjusting the rotational speed of the actuating motor in the driving mechanism, powering on and starting the driving mechanism and the welding mechanism, the welding mechanism beginning a welding operation, and the driving mechanism synchronously driving the rolling mechanism to roll the sheet metal to be welded and rolled, and dragging the sheet to move in the horizontal direction relying on the friction between the rotating roller and the sheet to realize the welding and the rolling at the same time.

Compared with the prior art, the present disclosure has the following advantages:

1. The composite forming method of the present disclosure make use of the synergistic plastic deformation of the weld reinforcement and the softened region of the welded joint to realize the deformation strengthening of the softened region of the welded joint and achieve the purpose of improving the comprehensive mechanical properties of the welded joint, such as the tensile strength and elongation etc., which will provide technical support for the design and manufacturing of high-performance welding parts.

2. The composite forming method of the present disclosure realizes the welding and the rolling synchronously, having the characteristic of short process. The method can realize the precise and integrated regulation of the structure and performance in the welding-rolling process by adjusting the rolling temperature and deformation degree, which expand the range of welding-rolling process parameters and greatly improve the production efficiency.

3. The composite forming method of the present disclosure can not only improve the softening problem of the welding seam zone and the heat affected zone of the welded joint, also can realize the compaction and welding of the welding pores and cracks existed in the welded joint and heat affected zone through the deformation treatment of the weld reinforcement of the welded joint, especially suitable for the metal materials easy to produce pores and the high strength metal materials easy to produce welding cracks.

4. The composite forming device of the present disclosure can accurately adjust the rolling deformation, the speeds of welding and rolling as well as the spatial position parameters of the welding gun and the roller, and realize the synergistic plastic deformation of the welding seam zone and the heat affected zone of the welded joint through the deformation treatment of the weld reinforcement of the welded joint, and realize the deformation strengthening of welded joint softened region and the compaction and welding of the welded joint pores and cracks.

In conclusion, the present disclosure discloses a welding-rolling integrated composite forming method for metal material and a device thereof, which can realize welding and rolling synchronously, having the characteristic of short process. The method and device can realize the precise and integrated regulation of the structure and performance in the welding-rolling process by adjusting the rolling temperature and deformation degree, which expand the range of welding-rolling process parameters, greatly improving the production efficiency. The present disclosure can solve the problem of the welded joint softening, and also be applied to eliminate the weld defects such as macro and micro pores and cracks existed in the welded joint, which greatly improve the comprehensive mechanical properties of the metal material welded joint and will greatly enhance the service performance and service life of the existing key welding parts.

Based on the above reasons, the present disclosure can be widely popularized in the field of metal material processing.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show some embodiments of the present disclosure, and a person of ordinary skill in the art may still derive other accompanying drawings from these accompanying drawings without creative efforts.

FIG. 1 is a principle schematic diagram of the welding-rolling integrated composite forming method for metal material of the present disclosure.

FIG. 2 is a structural schematic diagram of the welding-rolling integrated composite forming device for metal material of the present disclosure, wherein the rolling mechanism adopts double-roller structural form.

FIG. 3 is a structural schematic diagram of the welding-rolling integrated composite forming device for metal material of the present disclosure, wherein the rolling mechanism adopts single-roller structural form.

FIG. 4 is a structural schematic diagram of the lifting mechanism of the welding-rolling integrated composite forming device for metal material of the present disclosure.

FIG. 5 is a structural schematic diagram of the spatial size adjusting mechanism of the welding-rolling integrated composite forming device for metal material of the present disclosure.

FIG. 6 is a structural schematic diagram of the rotating distance adjusting device of the spatial size adjusting mechanism of the present disclosure.

FIG. 7 is a structural schematic diagram of the driving mechanism I when the rolling mechanism of the present disclosure adopts the double-roller structural form.

FIG. 8 is a structural schematic diagram of the driving mechanism II when the rolling mechanism of the present disclosure adopts the single-roller structural form.

FIG. 9 is a structural schematic diagram of the fixing mechanism II when the rolling mechanism of the present disclosure adopts the single-roller structural form.

In the figures:

1. lifting mechanism; 101. oil pump; 102. hydraulic push rod; 103. lifting base;

2. spatial size adjusting mechanism; 201. sliding block connector; 202. rotating distance adjusting device; 202a. moving end block; 202b. rotating shaft; 202c. fixing end block; 203. longitudinally moving sliding block; 204. horizontally moving sliding block; 205. Sliding block fixing base; 206. moving up and down sliding block; 207. clamping device;

3. welding mechanism; 301. wire feeding device; 302. welding gun;

4. upper roller I; 5. lower roller II;

6. driving mechanism I; 601. actuating motor I; 602. reducer; 603. bevel gear I; 604. bevel gear II; 605. bevel gear III; 606. bevel gear IV; 607. locknut; 608. gear shaft; 609. bevel gear V;

7. fixing mechanism; 8. frame I;

9. driving mechanism II; 901. actuating motor II; 902. gear; 903. rack;

10. frame II; 11. walking mechanism; 12. roller;

13. fixing mechanism II; 1301. bolt; 1302. support nut; 1303. press nut; 1304. splint;

14. sheet metal to be welded and rolled.

### DESCRIPTION OF THE EMBODIMENTS

It should be noted that the embodiments in the present disclosure and the features of the embodiments may be combined mutually without conflict. The present disclosure is described in detail below with reference to the accompanying drawings and the embodiments

To make the objectives, technical solutions, and advantages of the present disclosure clearer, the following clearly and completely describes the technical solutions in the embodiments of the present disclosure with reference to the accompanying drawings in the embodiments of the present disclosure. Apparently, the described embodiments are merely some rather than all of the embodiments. The following description of at least one exemplary embodiment is actually only illustrative, and in no way serves as any limitation on the present disclosure and its application or use. Based on the embodiments of the present disclosure, all the other embodiments obtained by those of ordinary skill in the art without inventive effort are within the protection scope of the present disclosure.

It should be noted that the terms used herein are only intended to describe specific implementations and are not intended to limit the exemplary implementations of the present disclosure As used herein, unless indicated obviously in the context, a singular form is intended to include a plural form. Furthermore, it should be further understood that the terms “include” and/or “comprise” used in this specification specify the presence of features, steps, operations, devices, components and/or of combinations thereof.

Unless specifically stated otherwise, the relative arrangement of components and steps, numerical expressions, and numerical values set forth in these embodiments do not limit the scope of the present invention. In addition, it should be clear that, for ease of description, sizes of the various components shown in the accompanying drawings are not drawn according to actual proportional relationships. Technologies, methods, and devices known to those of ordinary skill in the relevant fields may not be discussed in detail, but where appropriate, the technologies, methods, and devices should be considered as a part of the authorization specification. In all the examples shown and discussed herein, any specific value should be interpreted as merely being exemplary rather than limiting. Therefore, other examples of the exemplary embodiment may have different values. It should be noted that similar reference signs and letters represent similar items in the accompanying drawings below. Therefore, once an item is defined in one accompanying drawing, the item does not need to be further discussed in a subsequent accompanying drawing.

In the description of the present disclosure, it should be noted that orientations or position relationships indicated by orientation terms “front, rear, upper, lower, left, and right”, “transverse, vertical, perpendicular, and horizontal”, “top and bottom”, and the like are usually based on orientations or position relationships shown in the accompanying drawings, and these terms are only used to facilitate description of the present disclosure and simplification of the description. In the absence of description to the contrary, these orientation terms do not indicate or imply that the apparatus or element referred to must have a specific orientation or be constructed and operated in a specific orientation, and therefore cannot be understood as a limitation on the protection scope of the present disclosure: orientation words “inner and outer” refer to the inside and outside relative to the contour of each component.

For ease of description, spatially relative terms, such as “on”, “over”, “on the upper surface”, and “above”, can be used here to describe a spatial positional relationship between one device or feature and another device or feature shown in the figures. It should be understood that the spatially relative terms are intended to include different orientations in use or operation other than the orientation of the device described in the figure. For example, if the device in the figure is inverted, the device described as “above another device or structure” or “on another device or structure” is then be positioned as being “below another device or structure” or “beneath a device or structure”. Therefore, the exemplary term “above” can include both orientations “above” and “below”. The device can also be positioned in other different ways (rotating 90 degrees or in another orientation), and the spatially relative description used herein is explained accordingly.

In addition, it should be noted that using terms such as “first” and “second” to define components is only for the convenience of distinguishing the corresponding components. Unless otherwise stated, the foregoing words have no special meaning and therefore cannot be understood as a limitation on the protection scope of the present disclosure.

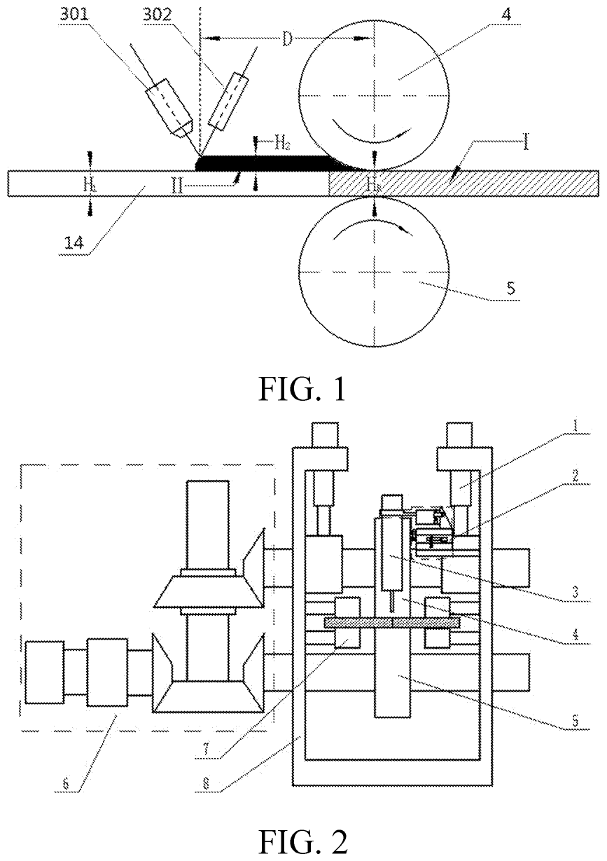

The present disclosure discloses a welding-rolling integrated composite forming method for metal material, which implements the welding-rolling integrated composite forming on metal material. FIG. 1 shows a principle schematic diagram of the integrated composite forming using a double-roller welding-rolling device.

The sheet metal to be welded and rolled 14 which can be implemented includes metal material strengthened by heat treatment, such as solution and aging treated high strength aluminum alloy after solution and aging treatments, quenched and tempered high strength steel and ultrahigh strength steel, etc.; the welded joints after the welding of the above metal materials are prone to softening at heat affected zone. Metal materials that can be implemented also include metal materials that are prone to generate welding pores and welding cracks, such as 2-series aluminum alloy, coated high strength steel plate and casting metal materials, etc.

Wherein, the welding process is carried out by the low heat input wire filling welding method combined with optimized welding technology. On the one hand, the low heat input wire filling welding method can obtain the welded joint with certain weld reinforcement; on the other hand, the softened region of the welded joint having the weakest performance can be close to the welding seam by optimizing the welding technology to control the welding heat input.

The low heat input wire filling welding method refers to welding with filler wire assisted by forced cooling such as water cooling, cold metal transition metal inert gas arc welding, high energy beam welding with filler wire and high energy beam-arc composite welding with filler wire, and other welding methods with filler wire having the same low heat input characteristics.

In the welding process, the optimized welding technology refers to optimize the wire filling amount of per unit welded joint length and the welding heat input, to make the position of the softened region of the welded joint related to the weld reinforcement of the welded joint, which depends on the material type and plate thickness of the sheet metal to be welded and rolled 14, that is, through subsequent rolling deformation to achieve the synergistic plastic deformation between the weld reinforcement and the softened region of the welded joint and the deformation strengthening of the softened region.

In the welding process, the weld reinforcement area of the welded joint is rolled by a rolling device synchronously. The rolling device is a double-roller device or a single-roller device, and a size of the roller is determined according to the material type and mechanical properties of the welded metal, rolling force, and the size of the weld reinforcement of the welded joint.

Specifically, by setting the distance D between the welding gun 302 and the roller, and the distance H_{R} between the rollers or the distance H between the roller and the surface of the sheet metal to be welded and rolled 14, the coordinated regulation of the rolling temperature and the rolling deformation is achieved. By using the plastic flow and deformation strengthening effect generated by the weld reinforcement of the welded joint in the rolling process, the precise control of the structure and properties in each area of the welded joint is achieved, and the defects such as welding pores and cracks can be improved also. The improvement of defects such as welding pores and cracks mainly refers to the realization of compaction and welding of micro and macro pores and welding cracks formed in welded joints and heat affected zones by controlling the deformation of the weld reinforcement.

The distance D between the welding gun 302 and the roller, a required cooling time ST of the welded joint to reach a set rolling temperature T and a rolling speed V have the following relation: D=S_{T}×V, in which the rolling temperature Tis determined according to a metal material plastic state diagram of the sheet metal to-be-welded and rolled and a deformation strengthening effect, and ST represents the cooling time from the peak temperature to the required rolling temperature in a welding thermal cycle curve at the rolling position.

The distance H_{R} between the rollers or the distance H between the roller and the surface of the sheet metal to be welded and rolled 14 is related to the metal material type of the sheet metal to be welded and rolled 14, a plate thickness H₁, a weld reinforcement H₂ of the welded joint and the required deformation strengthening effect, and H₁≤H_{R}<H₁+H₂ for the double-roller device and H<H₂ for the single-roller device.

The present disclosure also discloses a welding-rolling integrated composite forming device for metal material, which can be used in the above composite forming method, including a lifting mechanism 1, a spatial size adjusting mechanism 2, a welding mechanism 3, a rolling mechanism, a driving mechanism, a fixing mechanism and a frame. The rolling mechanism includes two welding-rolling forms of double-roller and single-roller, for the convenience of illustrating the technical solution of the present disclosure, the structures of the double-roller and single-roller welding-rolling device will be described respectively. The structure, relative arrangement and transmission relations of the components described in the following implementations do not limit the scope of the present disclosure.

As shown in FIG. 2, the double-roller welding-rolling device includes a lifting mechanism 1, a spatial size adjusting mechanism 2, a upper roller I 4, a lower roller II 5, a driving mechanism I 6, a fixing mechanism I 7 and a frame I 8. The frame I 8 is an integrated frame body having two side walls, and is a hollow structure having a upper opening.

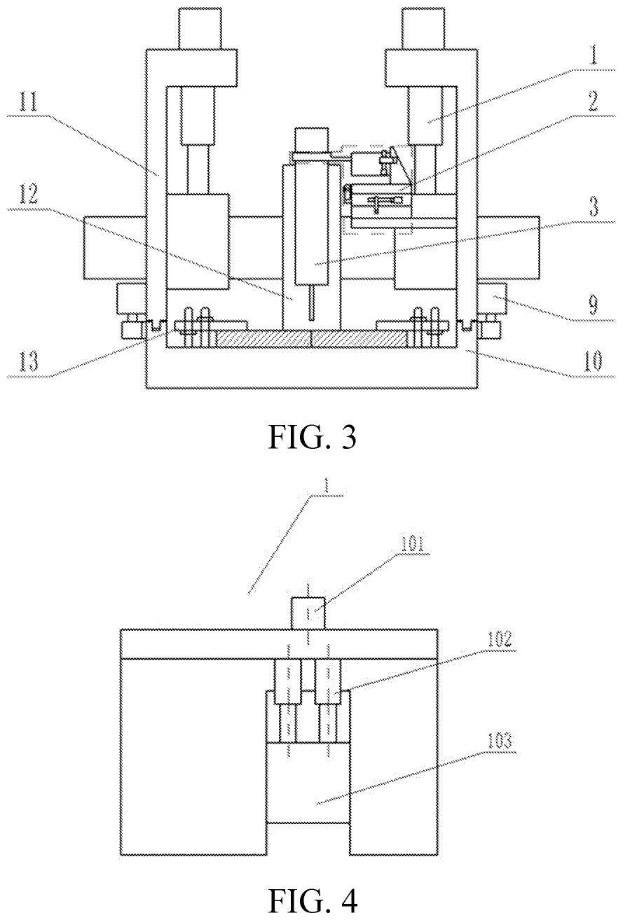

As shown in FIG. 4, two groups of the lifting mechanism 1 are arranged. The lifting mechanism includes oil pump 101, hydraulic push rod 102 and lifting base 103. Wherein, two hydraulic push rods 102 are arranged, whose fixed ends are fixed on the frame I 8 and the moving ends are fixed on the lifting bases 103. The lifting bases 103 respectively sliding fit with the sliding chutes on the side walls of the frame I, to realize up and down movement.

The upper roller I 4 is rotationally connected with the two lifting bases 103 of the two lifting mechanisms 1, the lower roller II is rotationally connected to the middle and lower part of the frame I 8. The rolling force applied to the upper roller I 4 by the metal sheet to be welded and rolled 14 is transmitted to the frame I 8 through the hydraulic push rod 102 and the lifting base 103, and the rolling force applied to the upper roller II 5 by the metal sheet to be welded and rolled 14 is directly transmitted to the frame I 8.

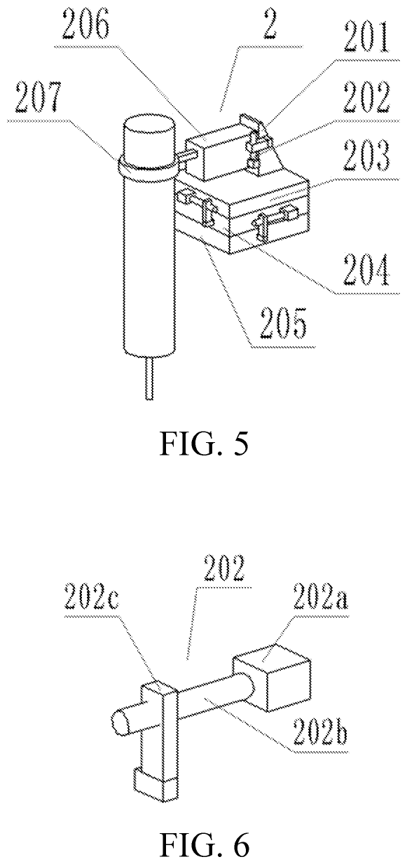

As shown in FIG. 5, the spatial size adjusting mechanism 2 includes sliding block connector 201, up and down moving sliding block 206, longitudinally moving sliding block 203, horizontally moving sliding block 204, rotating distance adjusting devices 202, sliding block fixing base 205 and clamping device 207. The fixed end of the clamping device 207 is rotationally connected with the fixed end of the up and down moving sliding block 206, and the other end of the clamping device 207 clamps the welding gun mechanism 3. The mobile end of the up and down moving sliding block 206 sliding fits on the sliding block connector 201. The sliding block connector 201 is fixed on the longitudinally moving sliding block 203. The longitudinally moving sliding block 203 sliding fits on the horizontally moving sliding block 204, and the horizontally moving sliding block 204 sliding fits on the sliding block fixing base 205. The rotating distance adjusting devices 202 are respectively fixed on the up and down moving sliding block 206 and the sliding block connector 201, the longitudinally moving sliding block 203 and the horizontally moving sliding block 204, and the horizontally moving sliding block 204 and the sliding block fixing base 205.

As shown in FIG. 6, the rotating distance adjusting device 202 includes a mobile end block 202a, a rotating shaft 202b and a fixing end block 202c. The one end of the rotating shaft is rotationally connected with the fixing end block 202c, and the other end of the rotating shaft 202b is fitted to the moving end block 202a by contact. The fixing end blocks 202c are respectively fixed on the sliding block fixing base 205, the horizontally moving sliding block 204 and the sliding block connector 201. The moving end blocks 202a are respectively fixed on the horizontally moving sliding block 204, the longitudinally moving sliding block 203 and the up and down moving sliding block 206.

The welding mechanism 3 adopts the low heat input wire filling method, and includes a wire feeding device 301, a welding gun 302 and a welding heat source. The low heat input welding with filler wire mainly includes high energy beam welding with filler wire, high energy beam-arc composite welding with filler wire, cold metal transition metal inert gas arc welding, alternating current gas metal arc welding and other low heat input welding methods with filler wire.

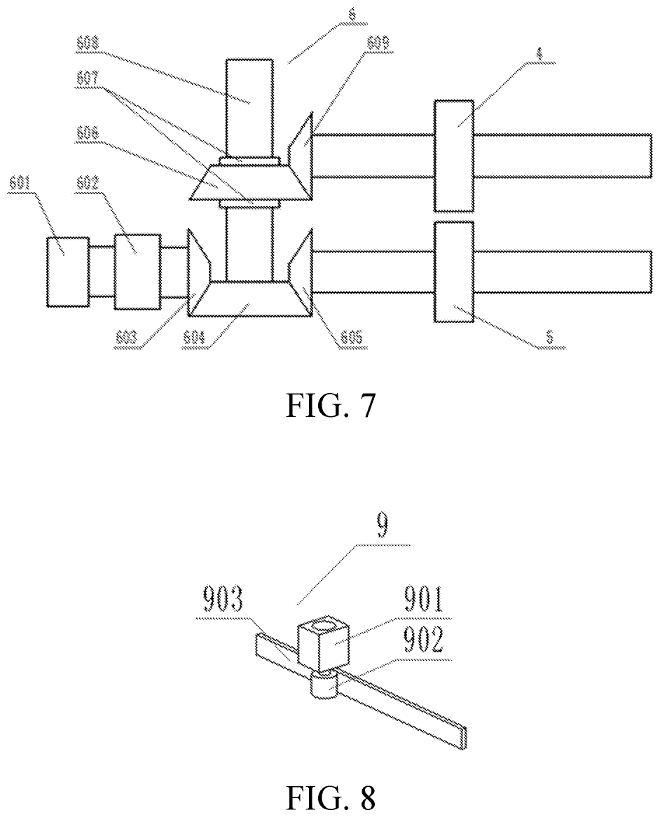

As shown in FIG. 7, the driving mechanism I 6 includes an actuating motor I 601, a reducer 602, a bevel gear I 603, a bevel gear II 604, a bevel gear III 605, a bevel gear IV 606, a locknut 607, a gear shaft 608 and a bevel gear V 609. The output shaft of the actuating motor 601, the reducer 602 and the bevel gear I 603 are successively connected by key drive. The bevel gear II 604 is fixed on the gear shaft 608, and is respectively in meshing drive with the bevel gear I 603 and the bevel gear III 605. The bevel gear IV 606 is in key connection with the gear shaft 608, and in meshing drive with the bevel gear V 609, and is axially fixed on the gear shaft 608 by the locknut 607. The bevel gear V 609 and the bevel gear III 605 are respectively in drive connection with the upper roller I 4 and the lower roller II 5.

The fixing mechanism I 7 can be a clamping pulley which is roll fit on the surface of the sheet metal to be welded and rolled 14; the clamping pulley only limits the sheet metal up and down fluctuations and does not affect the movement of the sheet metal in the horizontal direction. The clamping pulley is fixed on the frame I 8 by a shaft passing through the pulley center, and its position in vertical direction can be adjusted according to the thickness of the sheet metal to be welded and rolled 14. Preferably, there are 8 clamping pulleys, which are respectively set on the upper and lower surfaces near the 4 corners of the sheet metal.

The fixing mechanism 17 is also provided with a cooling device having an effect of shunting the fusion welding heat source.

The welding-rolling method of the above double-roller welding-rolling device includes the following steps:

S1. the sheet metal to be welded and rolled 14 is inserted between the upper and lower clamping pulleys.

S2. according to a preset rolling reduction, the upper roller I and the lower roller II 5 are controlled to fix their spatial positions by the lifting mechanism 1, and then the driving mechanism I 6 is adjusted so that the gears can be normal meshing drive.

S3. according to the thickness of the sheet metal to be welded and rolled 14, the distance between the clamping pulleys in the fixing mechanism I 7 is adjusted, so that the clamping pulleys limit the sheet metal up and down fluctuations and do not affect the movement of the sheet metal in the horizontal direction.

S4. according to the position of the sheet metal to be welded and rolled 14, the preset welding parameters and the preset distances between the welding gun 302 and the upper and lower rollers, the spatial position of the welding mechanism 3 is adjusted by the spatial size adjusting mechanism 3 to make its spatial position fixed.

S5. according to the welding speed and the rolling speed, the rotational speed of the actuating motor I 601 in the driving mechanism I 6 is adjusted, the driving mechanism I 6 and the welding mechanism 3 are powered on and started at the same time. The welding mechanism 3 begins to welding operation, while the driving mechanism I 6 drives the upper roller I 4 and the lower roller I 5 to roll the sheet metal to-be-welded and rolled 14. Relying on the friction between the rotating roller and the sheet metal, the sheet metal is dragged to move in the horizontal direction to realize the purpose of welding and rolling at the same time.

As shown in FIG. 3, the single-roller welding-rolling device includes lifting mechanisms 1, a spatial size adjusting mechanism 2, a welding mechanism 3, a driving mechanisms II 9, a frame II 10, walking mechanisms 11, a roller 12 and fixing mechanisms II 13.

Wherein, the lifting mechanism 1, the spatial size adjusting mechanism 2 and the welding mechanism 3 are the same as the double-roller welding rolling device. The frame II 10 is a split-type frame body; the walking mechanism 11 having moving feature on the upper part of the frame moves horizontally along the fixed frame base at the lower part of the frame by the sliding chute track.

The roller 12 rotationally contacts to the lifting base 103 of the lifting mechanism 1.

The lifting mechanism 1 and the spatial size adjusting mechanism 2 are both fixed on the walking mechanism 11.

As shown in FIG. 8, the driving mechanism II 9 includes an actuating motor 901, a gear 902 and a rack 903. The actuating motor II 901 is fixed on the walking mechanism, and the output shaft of the actuating motor II 901 is connected to the gear 902 by key drive. The gear 902 is in meshing drive with the rack 903, and the rack 903 is fixed on the frame body base of the frame.

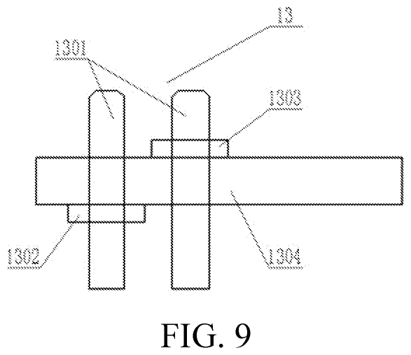

As shown in FIG. 9, the fixing mechanism II 13 includes bolts 1301, a support nut 1302, a press nut 1303 and a splint 1304. The bolt 1301 is fixed on the frame II 10 through the threaded connection. The splint 1304 is horizontally pressed on the sheet metal to be welded and rolled 14 and the support nut 1302, and clamps the sheet metal to be welded and rolled 14 tightly through the press nut 1303. The fixing mechanism II 13 can be provided with the same cooling device as the double-roller welding-rolling device.

The frame II 10 is provided with a series of threaded holes, which can adjust the position of the fixing mechanism II 13 on the frame II 10 according to the size of the sheet metal to be welded and rolled.

The welding-rolling method of the above single-roller welding-rolling device includes the following steps:

S1. the sheet metal to be welded and rolled 14 is inserted into the fixing mechanism II 13, and is pressed tightly by adjusting the nut of the fixing mechanism II 13 according to the size of the sheet metal to be welded and rolled 14.

S2. according to a preset rolling reduction, the distance between the roller 12 and the sheet metal to be welded and rolled is controlled through the lifting mechanism 1.

S3. according to the position of the sheet metal to be welded and rolled 14, the preset welding parameters and the preset distance between the welding mechanism 3 and the roller 12, the spatial position of the welding mechanism 3 is adjusted through the spatial size adjusting mechanism 2.

S4. according to the welding speed and the rolling speed, the rotational speed of the actuating motor II 901 in the driving mechanism II 9 is adjusted, and the driving mechanism II 9 and the welding mechanism 3 are powered on and started at the same time. The welding mechanism 3 begins to welding operation, while the driving mechanism II drives the walking mechanism 11 to move on the frame body base, so that the rolling is completed synchronously.

### Embodiment 1

As shown in FIG. 2 is a double-roller welding-rolling device. When the sheet metal is welded and rolled, first the upper roller I 4 is driven up by controlling the two lifting mechanisms 1, and the clamping pulleys at the middle and upper part of the fixing mechanism 7 are moved upward. The sheet metal to be welded and rolled passes through the gap between the upper roller I 4 and the lower roller II 5, and the sheet metal to be welded and rolled 14 is clamped between the clamping pulleys (on the upper and lower surfaces of the sheet metal) of the fixing mechanism I 7. According to the preset rolling reduction, the two lifting mechanisms 1 are controlled to drive the roller I 4 down, so that the upper roller I 4 and the lower roller II 5 are cooperated in accordance with the preset rolling data, and their spatial positions relative to the frame I 8 is fixed. The driving mechanism I 6 is adjusted so that the gears can be normal meshing drive. According to the thickness of the sheet metal to be welded and rolled 14, the fixing mechanism I 7 is adjusted, so that the clamping pulleys clamp the sheet metal to limit the up and down fluctuations of that and does not affect the movement in the horizontal direction. According to the position of the sheet metal to be welded and rolled 14, the preset welding parameters and the preset distance between the welding mechanism 3 and the upper roller I 4, the spatial position of the welding mechanism 3 is adjusted by the spatial size adjusting mechanism 2, and the spatial position of the welding mechanism 3 relative to the frame I 8 is fixed. According to the welding speed and the rolling speed, the rotational speed of the actuating motor I 601 in the driving mechanism I 6 is adjusted. At last, the driving mechanism I 6 and the welding mechanism 3 are powered on and started at the same time, the welding mechanism 3 begins to weld, while the driving mechanism I 6 drives the upper roller I 4 and the lower roller I 5 to roll the sheet metal to be welded and rolled 14. Relying on the friction between the rotating roller and the sheet metal, the sheet metal is dragged to move in the horizontal direction, realizing the welding and rolling at the same time.

### Embodiment 2

As shown in FIG. 3, the device is a single-roller welding-rolling device. When the sheet metal is welded and rolled, first the roller 12 is driven up by the two lifting mechanisms 1, then the sheet metal to be welded and rolled is inserted into the fixing mechanism II 13, and is pressed tightly by adjusting the nut of the fixing mechanism II 13 according to the size of the sheet metal to be welded and rolled 14. According to a preset rolling reduction, the roller 12 is driven down by controlling the two lifting mechanisms 1. According to the position of the sheet metal to be welded and rolled 14, the preset welding parameters and the preset distance between the welding mechanism 3 and the roller 12, the spatial position of the welding mechanism 3 is adjusted by the spatial size adjusting mechanism 2. According to the welding speed and the rolling speed, the rotational speed of the actuating motor II 901 in the driving mechanism II 9 is adjusted. At last, the driving mechanism II 9 and the welding mechanism 3 are powered on and started at the same time. The welding mechanism 3 begins to weld, while the driving mechanism II drives the walking mechanism 11 to move on the frame body base, so that the rolling is completed synchronously.

The double-roller welding-rolling device in Embodiment 1 above is used to perform welding-rolling composite forming of different metal materials, as follows:

### Embodiment 3 Welding-Rolling Composite Forming of 6061-T6 Aluminum Alloy with a Thickness of 1.5 mm

As shown in the principle schematic diagram of FIG. 1, the welding object is 6061-T6 aluminum alloy with a thickness H₁ of 1.5 mm (i.e., the sheet metal to be welded and rolled 14 in the figure), having a size of 100 mm×50 mm×1.5 mm. The welding gun 302 adopts laser-tungsten insert gas (TIG) welding with filler wire using hybrid welding heat source. The main welding parameters are as follows: the average power of YAG pulse laser of 900 W, the welding current of the tungsten insert gas arc welding of 100 A, the height of the tungsten electrode of 2 mm, the welding speed of 600 mm/min, the wire feeding speed of the wire feeding device 301 of 6500 mm/min, the welding wire brand of ER5356, the wire feeding angle of 20°, the weld reinforcement of the welding joint 112 of 2.0 mm, the distance D between the laser action point and the roller of 240 mm, and the distance H_{R} between the two rollers (i.e., the space between the upper roller I 4 and the lower roller I 5) of 1.5 mm. In the figure, rolling from the right to left, area I represents the rolled area, and area II represents the weld reinforcement area of the welded joint.

By using the above welding-rolling composite forming method, the tensile strength of the obtained welded piece can reach more than 90% of that of 6061-T6 base metal and the elongation more than 80% of that. However, the tensile strength of the welded piece by tungsten insert gas arc welding alone is only 62.5% of the 6061-T6 base metal and the elongation about 50% of the 6061-T6 base metal.

### Embodiment 4 Welding-Rolling Composite Forming of 5083-0 Aluminum Alloy with a Thickness of 2.5 mm and 6061-T6 Aluminum Alloy with a Thickness of 2.5 mm

The welding objects are 5083-0 aluminum alloy with thickness H₁ of 2.5 mm and 6061-T6 aluminum alloy with the same thickness, both having a size of 200 mm×100 mm×2.5 mm. The welding heat source adopts a cold metal transition arc (CMT) welding heat source, and the main welding parameters are as follows: the current of the cold metal transition arc of 120 A, the arc voltage of 14.8 V, the welding speed of 550 mm/min, the wire feeding speed of 8000 mm/min, the welding wire brand of ER5356, the weld reinforcement H₂ of the welded joint after welded of 2.4 mm, the distance D between the arc welding gun and the roller of 200 mm, and the distance HR between the two rollers of the rolling process of 2.5 mm.

By using the above welding-rolling composite forming method, the tensile strength of the obtained welded piece can reach 100% of the 5083-0 base metal and 90% of the 6061-T6 base metal, and the elongation more than 85% of the 6061-T6 base metal. However, when the cold metal transition arc welding processing is adopted, the tensile strength of the welded piece is only 70% of 6061-T6 base metal, and the elongation is about 55% of 6061-T6 base metal.

At last, it should be stated that the above various embodiments are only used to illustrate the technical solutions of the present disclosure without limitation; and despite reference to the aforementioned embodiments to make a detailed description of the present invention, those of ordinary skilled in the art should understand: the described technical solutions in above various embodiments may be modified or the part of or all technical features may be equivalently substituted; while these modifications or substitutions do not make the essence of their corresponding technical solutions deviate from the scope of the technical solutions of the embodiments of the present disclosure.

1. A welding-rolling integrated composite forming method for metal material, implementing the welding-rolling integrated composite forming on a sheet metal to be welded and rolled, wherein obtaining a welded joint with a certain weld reinforcement by using a low heat input wire filling welding method in the welding process, and controlling the welding heat input to make a softened region with the weakest performance of the welded joint close to a welding seam; in the welding process, rolling a weld reinforcement area of the welded joint by a rolling device simultaneously; and realizing coordinated regulation of a rolling temperature and a rolling deformation by setting a distance D between a welding gun and a roller and a distance HR between the rollers or a distance H between the roller and the surface of the sheet metal to be welded and rolled.

2. The welding-rolling integrated composite forming method for metal material according to claim 1, wherein the sheet metal to be welded and rolled comprises a sheet metal whose welded joint is prone to generate heat affected zone softening or a sheet metal which is prone to generate welding pores and welding cracks.

3. The welding-rolling integrated composite forming method for metal material according to claim 1, wherein the sheet metal is selected from but not limited to high strength aluminum alloy after solid solution and aging heat treatments, high strength steel after quenching and tempering treatments, ultra-high strength steel, 2-series aluminum alloy, coated high strength steel plate and casting metal materials.

4. The welding-rolling integrated composite forming method for metal material according to claim 1, wherein the low heat input wire filling welding method refers to welding with filler wire assisted by forced cooling, cold metal transition metal inert gas arc welding, high energy beam welding with filler wire and high energy beam-arc composite wire filling welding method and other welding methods with filler wire having the same low heat input characteristics.

5. The welding-rolling integrated composite forming method for metal material according to claim 1, wherein in the welding process, according to the material types and a plate thickness of the metal, optimizing a wire filling quantity of per unit welded joint length and welding heat input, to make a position of the softened region of the welded joint related to the weld reinforcement of the welded joint, namely through subsequent rolling deformation to achieve synergistic plastic deformation between the reinforcement and the softened region of the welded joint, and to achieve the deformation strengthening of the softened region.

6. The welding-rolling integrated composite forming method for metal material according to claim 1, wherein the rolling device is a double-roller device or a single-roller device, and a size of the roller is determined according to the material type and mechanical properties of the welded sheet metal, rolling force, and the size of the weld reinforcement of the welded joint.

7. The welding-rolling integrated composite forming method for metal material according to claim 1, wherein the distance D between the welding gun and the roller, a required cooling time ST of the welded joint reaching a set rolling temperature T, and a rolling speed V have a relation of D=ST×V, wherein the rolling temperature T is determined according to a metal material plastic state diagram of the sheet metal to be welded and rolled and a deformation strengthening effect, and ST represents the cooling time from the peak temperature to the required rolling temperature in a welding thermal cycle curve at the rolling position.

8. The welding-rolling integrated composite forming method for metal material according to claim 6, wherein the distance HR between the rollers or the distance H between the roller and the surface of the sheet metal to be welded and rolled is related to the metal material type of the sheet metal to be welded and rolled, a plate thickness H1, a weld reinforcement H2 of the welded joint and the required deformation strengthening effect, and H1≤HR<H1+H2 for the double-roller device and H<H2 for the single-roller device.

9. A welding-rolling integrated composite forming device for metal material, comprising:
a frame being an integral or a split-type frame body having a support structure, which is used for fixing a lifting mechanism and a spatial size adjusting mechanism;
a lifting mechanism cooperating with a rolling mechanism, to adjust the distance between the rolling mechanism and the sheet metal to be welded and rolled, wherein the sheet metal to be welded and rolled is clamped by a fixing mechanism fixed on the frame to limit its fluctuation in the vertical direction or its movement in all directions;
a spatial size adjusting mechanism, to clamp a welding mechanism and adjust the positions of the welding mechanism and the sheet metal to be welded and rolled and a relative distance between the welding mechanism and the rolling mechanism;
a welding mechanism having a characteristic of low heat input wire filling welding, to weld the sheet metal to be welded and rolled, to obtain a welded joint with a certain weld reinforcement; and
a rolling mechanism driven by a driving mechanism, to synchronously roll the weld reinforcement of the welded joint.

10. The welding-rolling integrated composite forming device for metal material according to claim 9, wherein two groups of the lifting mechanism are arranged; the lifting mechanism is in a structural form of hydraulic push rod matching with lifting seat, and is driven by oil pump; a fixed end of the hydraulic push rod is fixed on the frame, and a moving end is fixed on the lifting seat; and the lifting seat sliding fits in sliding chutes on side walls of the frame to realize up and down movement.

11. The welding-rolling integrated composite forming device for metal material according to claim 9, wherein the spatial size adjusting mechanism adopts a structural form of sliding blocks cooperated with a rotating distance adjusting device, the sliding blocks including up and down moving sliding block and horizontally and vertically moving sliding block; the up and down moving sliding block and the horizontally and vertically moving sliding block are combined by the rotating distance adjusting device and a welding gun is clamped by a clamping mechanism to adjust the welding position.

12. The welding-rolling integrated composite forming device for metal material according to claim 11, wherein the rotating distance adjusting device adopts a form of rotating shaft cooperating with moving end block and fixing end block that are respectively fixed on the corresponding moving sliding blocks to adjust the relative position between the moving sliding blocks.

13. The welding-rolling integrated composite forming device for metal material according to claim 9, wherein the welding mechanism comprises a wire feeding device, a welding gun and a welding heat source; the characteristics of the low heat input welding with filler wire refers to but not limited to high energy beam welding with filler wire, high energy beam-arc composite welding with filler wire, cold metal transition metal inert gas arc welding, alternating current metal gas arc welding and other welding methods with filler wire having the same low heat input.

14. The welding-rolling integrated composite forming device for metal material according to claim 9, wherein the rolling mechanism adopts a double-roller or a single-roller structure form.

15. The welding-rolling integrated composite forming device for metal material according to claim 15, wherein when the rolling mechanism adopts the double-roller structure, a upper roller is rotationally connected to the two lifting seats of the lifting mechanism, and a lower roller is rotationally connected to the middle and lower part of the frame; and accordingly, the driving mechanism is drivingly connected to the upper and lower rollers by adopting an actuating motor cooperating with a reducer and a gear set.

16. The welding-rolling integrated composite forming device for metal material according to claim 14, wherein when the rolling mechanism adopts the single-roller structure, the frame adopts a split-type frame, at the upper part a walking mechanism having movement characteristics moves horizontally along a fixed frame base at the lower part through a sliding chute track; the lifting mechanism and the spatial size adjusting mechanism are all fixed on the walking mechanism, and the roller is rotationally connected to the two lifting seats in the lifting mechanism; and accordingly, the driving mechanism is drivingly connected to the walking mechanism and the frame base by adopting an actuating motor cooperating with a gear and a rack.

17. The welding-rolling integrated composite forming device for metal material according to claim 9, wherein the fixing mechanism is provided with a cooling device to shunt fusion welding heat source.

18. A welding-rolling method of the welding-rolling integrated composite forming device for metal material according to claim 9, comprising the following steps:
S1. inserting the sheet metal to be welded and rolled into the fixing mechanism, according to the size of the sheet metal to be welded and rolled, adjusting and pressing it;
S2. according to a preset rolling reduction, controlling the rolling mechanism by the lifting mechanism to adjust the distance between the roller and the surface of the sheet metal to be welded and rolled, and to adjust the driving mechanism to drive normally;
S3. according to the position of the sheet metal to be welded and rolled, preset welding parameters and the preset distance between the welding gun and the roller, adjusting a spatial position of the welding mechanism by the spatial size adjusting mechanism, to make the spatial position fixed; and
S4. according to the welding speed and the rolling speed, adjusting the rotational speed of the actuating motor in the driving mechanism, powering on and starting the driving mechanism and the welding mechanism at the same time, the welding mechanism beginning to weld, while the driving mechanism synchronously driving the rolling mechanism to roll the sheet metal to be welded and rolled, and dragging the sheet metal to move in the horizontal direction relying on the friction between the rotating roller and the sheet metal to realize the welding and the rolling at the same time.
